(19) United States
(12) Patent Application Publication
(10) Pub. No.: US 2026/0225388 A1
(43) Pub. Date: Aug. 6, 2026

(54) PRINTING DEVICE AND PRINTING CONTROL METHOD

(71) Applicant: SEIKO EPSON CORPORATION, TOKYO (JP)

(72) Inventor: Yasuhiro HOSODA, CHIKUHOKU-MURA (JP)

(21) Appl. No.: 19/530,732

(22) Filed: Feb. 5, 2026

(30) Foreign Application Priority Data
Feb. 5, 2025 (JP) 2025-017452

(51) Int. Cl. B41J 29/393; B41J 3/44; B41J 15/04

(52) U.S. Cl. CPC B41J 29/393; B41J 3/44; B41J 15/04

(57) ABSTRACT

In a case where a job is interrupted and resumed, when a printing unit prints identification information indicating occurrence of interruption of printing, and then resumes the interrupted job, and when a region of a printing medium in a first direction that has been subjected to printing before the interruption of the job is defined as a first image region, and a region of the printing medium in the first direction that has been subjected to printing by the printing unit after the interruption is defined as a second image region, the printing control unit causes a reading unit to read a first image included in the first image region and a second image included in the second image region, acquires distance information that is information regarding a distance between the first image region and the second image region, and associates the identification information with the distance information.

The present application is based on, and claims priority from JP Application Serial Number 2025-017452, filed February 5, 2025, the disclosure of which is hereby incorporated by reference herein in its entirety.

### BACKGROUND

### Technical Field

The present disclosure relates to a printing device and a printing control method.

### Related Art

In the related art, there is known a technique of resuming printing after interruption of a print job for continuously performing the printing. For example, in JP-A-2012-200976, a timing mark is printed for each picture in a digital printing method in which printing is suspended and then the printing is performed again by forward feeding. Then, a timing at the time of reverse feeding and a timing at the time of re-forward feeding are counted by a mark sensor, and printing is started when a count number of the timing marks at the time of re-forward feeding reaches a count number of the timing marks at the time of reverse feeding.

JP-A-2012-200976 is an example of the related art.

It is difficult to accurately control a transport amount in a configuration in which a printing medium is transported in a direction opposite to a transport direction during printing and resumed after the interruption . Therefore, a printing position after the resumption may be deviated from a printing position when the printing is not interrupted. When the printing position is deviated from a planned printing position, it is desired that the degree of deviation can be grasped.

### SUMMARY

A printing device according to one embodiment includes: a printing unit configured to print an image on a printing medium; a transport unit configured to move the printing medium relative to the printing unit in a first direction; a reading unit configured to read the image printed on the printing medium; and a printing control unit configured to control the printing unit, the transport unit, and the reading unit, in which the printing control unit causes the transport unit to move the printing medium relative to the printing unit in the first direction, interrupts execution of a job, in which the printing unit continuously prints a plurality of images on the printing medium, when an interruption instruction is received during the execution of the job, and causes the printing unit to print identification information indicating occurrence of interruption of printing, and then resumes the interrupted job when a resumption instruction is received, and when a region of the printing medium in the first direction that has been subjected to printing by the printing unit before the interruption is defined as a first image region, and a region of the printing medium in the first direction that has been subjected to printing by the printing unit after the interruption is defined as a second image region, the printing control unit causes the reading unit to read a first image included in the first image region and a second image included in the second image region, acquires distance information that is information regarding a distance between the first image region and the second image region, and associates the identification information with the distance information.

A printing control method according to one embodiment, which controls a printing unit configured to print an image on a printing medium, a transport unit configured to move the printing medium relative to the printing unit in a first direction, and a reading unit configured to read the image printed on the printing medium, includes: causing the transport unit to move the printing medium relative to the printing unit in the first direction, causing the printing unit to interrupt the execution of a job, execution of a job, in which the printing unit continuously prints a plurality of images on the printing medium, when an interruption instruction is received during the execution of the job, and printing, by the printing unit, identification information indicating occurrence of interruption of printing, and then resuming the interrupted job when a resumption instruction is received; and when a region of the printing medium in the first direction that has been subjected to printing by the printing unit before the interruption is defined as a first image region, and a region of the printing medium in the first direction that has been subjected to printing by the printing unit after the interruption is defined as a second image region, reading, by the reading unit, a first image included in the first image region and a second image included in the second image region, and associating the identification information with distance information that is information regarding a distance between the first image region and the second image region.

### BRIEF DESCRIPTION OF THE DRAWINGS

FIG. 1 is a block diagram showing a configuration of a printing device.

FIG. 2 is a diagram showing a specific configuration of the printing device.

FIG. 3 is a block diagram showing a configuration of a post-processing device.

FIG. 4 is a flowchart of printing processing.

FIG. 5 is a diagram schematically showing a relationship among a printing medium, a printing unit, and a reading unit.

FIG. 6 is a diagram schematically showing a relationship among the printing medium, the printing unit, and the reading unit.

FIG. 7 is a diagram schematically showing a relationship among the printing medium, the printing unit, and the reading unit.

FIG. 8 is a diagram schematically showing a relationship among the printing medium, the printing unit, and the reading unit.

FIG. 9 is a diagram schematically showing a relationship among the printing medium, the printing unit, and the reading unit.

FIG. 10 is a flowchart of post-processing.

FIG. 11 is a diagram schematically showing a relationship among the printing medium, a post-processing unit, and the reading unit.

FIG. 12 is a diagram schematically showing a relationship among the printing medium, the post-processing unit, and the reading unit.

FIG. 13 is a diagram schematically showing a relationship among the printing medium, the post-processing unit, and the reading unit.

FIG. 14 is a diagram schematically showing a relationship among the printing medium, the post-processing unit, and the reading unit.

FIG. 15 is a diagram schematically showing a relationship among the printing medium, the printing unit, and the reading unit.

### DESCRIPTION OF EMBODIMENTS

Embodiments of the disclosure will be described herein in the following order.

(1) Configuration of Printing Device

(2) Configuration of Post-Processing Device

(3) Printing Processing

(4) Post-Processing

(5) Other embodiments

### Configuration of Printing Device

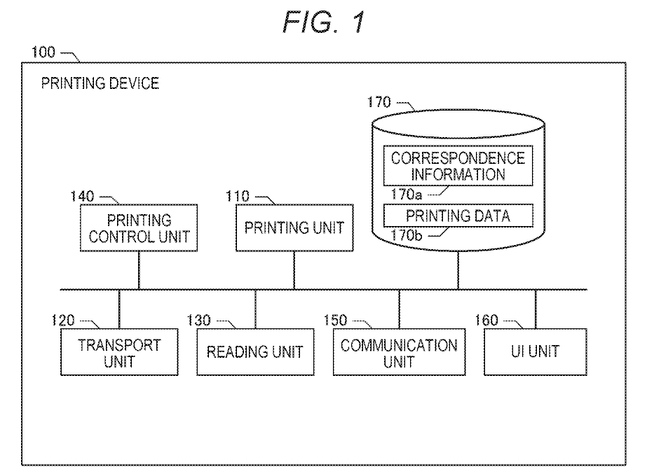

FIG. 1 is a diagram showing a configuration of a printing device 100 according to an embodiment of the disclosure. In the embodiment, the printing device 100 and a post-processing device 200, which will be described later, are disposed side by side, and printing media printed in the printing device 100 are continuously transported to the post-processing device 200. The post-processing device 200 is a device that performs post-processing, which is performed after printing, on the printing medium after printing. The type of the post-processing is not limited, but in the embodiment, the post-processing is performed in which a blade of a blade mold is pressed against the printing medium to punch the printing medium into a predetermined shape.

The printing device 100 is a device that prints a predetermined image on the printing medium to be post-processed by the post-processing device 200. The printing device 100 includes a printing unit 110, a transport unit 120, a reading unit 130, a printing control unit 140, a communication unit 150, a UI unit 160, and a nonvolatile memory 170.

The printing control unit 140 includes a CPU as a processor, a ROM, a RAM, and the like, and can execute various programs stored in the nonvolatile memory 170. In the embodiment, the printing control unit 140 can control each unit of the printing device 100 by various programs. That is, the printing control unit 140 can control the printing unit 110, the transport unit 120, the reading unit 130, the communication unit 150, the UI unit 160, and the nonvolatile memory 170.

The printing control unit 140 may be implemented by a single chip, may be implemented by a plurality of chips, or may be implemented as an SoC with various function blocks that operate the printing device 100. As the processor, an ASIC may be adopted instead of the CPU, or the CPU and the ASIC may cooperate with each other.

Any information can be stored in the nonvolatile memory 170. In the embodiment, correspondence information 170a and printing data 170b are stored. The correspondence information 170a is information in which identification information indicating occurrence of interruption of printing is associated with distance information which is information regarding a distance between printing regions (a first image region and a second image region which will be described later) which become discontinuous due to the interruption of the printing, and details thereof will be described later. The printing data 170b indicates data indicating an image to be printed and a setting for printing the image. That is, the printing data 170b is data for executing a print job. In the embodiment, the printing data 170b includes data for printing an image of a portion to be punched by post-processing and an image indicating a position of the image (hereinafter referred to as an eye mark) and is generated in advance.

The printing unit 110 is a device that prints an image on a printing medium. In the embodiment, the printing unit 110 executes printing on a printing medium accumulated in a roll shape. The printing unit 110 includes a printing head including nozzle arrays corresponding to color materials, for example, inks of cyan, magenta, yellow, and black. Each nozzle of the printing head ejects ink onto the printing medium. The printing unit 110 can print any image on the printing medium. Therefore, the printing unit 110 can print an image and an eye mark of the portion to be punched by post-processing. In the embodiment, when the job is interrupted and resumed, the printing unit 110 prints a two-dimensional code as the identification information on the printing medium. Examples of these images will be described later.

The transport unit 120 is a device that moves the printing unit and the printing medium relative to each other in a first direction. In the embodiment, the transport unit 120 is a device that transports the printing medium. In the embodiment, a direction in which the printing medium is transported during printing is defined as the first direction (transport direction). That is, the first direction is a longitudinal direction of the printing medium accumulated in a roll shape. The printing medium changes an orientation in various directions in a transport path, and the direction in which the printing medium is transported is the first direction at any position. For example, on a roll, a circumferential direction along a circumference of the roll is the first direction.

A user sets the printing medium accumulated in a roll shape in the printing device 100 and operates the printing device 100 to instruct the printing device 100 to execute printing. When the printed printing medium is transported by the transport unit 120 and discharged from the printing device 100, the printed printing medium is taken into the post-processing device 200 through a buffer device 300. That is, the printing medium discharged from the printing device 100 is continuously transported to the post-processing device 200. Then, the post-processing is performed in the post-processing device 200.

The reading unit 130 is a device that reads an eye mark that is the image printed on the printing medium. The reading unit 130 is disposed downstream of the position of the printing unit 110, that is, on the first direction side in the transport path of the printing medium. The printing data 170b according to the embodiment is data for printing the eye mark at a predetermined position on the printing medium. Specifically, the eye mark has a predetermined shape (a rectangle in the embodiment) and is printed at a position having a predetermined relative positional relationship with respect to the image of the portion to be punched by post-processing. Further, the position of the eye mark to be printed in a direction (width direction of the printing medium) perpendicular to the first direction is determined in advance.

The reading unit 130 is disposed in the printing device 100 such that the position where the eye mark is printed in the direction (width direction of the printing medium) perpendicular to the first direction is a reading range, and can read the eye mark in a process of transporting the printing medium after printing.

The communication unit 150 includes a communication interface for communicating with another device according to various protocols for wired or wireless communication. In the embodiment, the printing control unit 140 can communicate with the post-processing device 200 via the communication unit 150. The communication unit 150 may include an interface for communicating with various removable memories attached to the printing device 100.

The UI unit 160 includes a touch panel display, a key, an LED, a speaker, and the like. The printing control unit 140 guides the user to various types of information via an output unit such as a touch panel display, an LED, or a speaker, and inputs an instruction of the user via an input unit such as a touch panel display or a key. In the embodiment, the user can issue an interruption instruction and a resumption instruction for the job by using the UI unit 160.

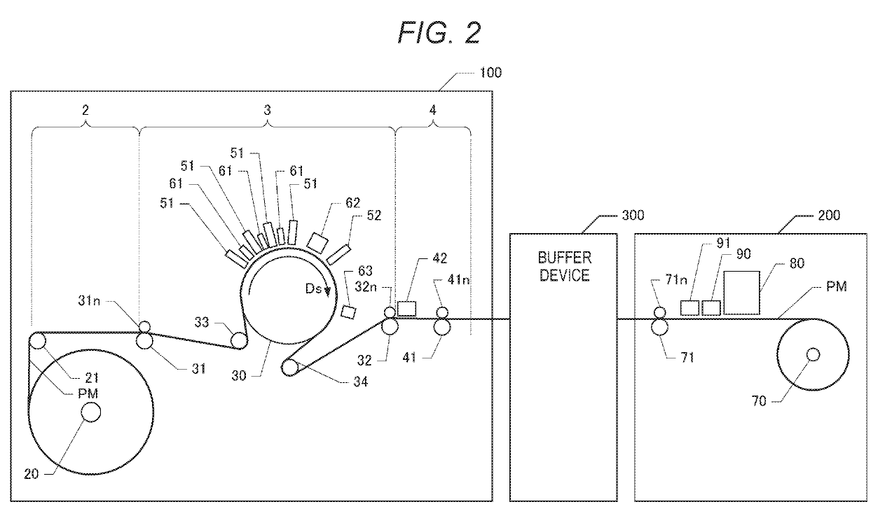

FIG. 2 is a diagram showing a configuration example of the printing unit 110, the transport unit 120, and the reading unit 130 of the printing device 100. In the printing device 100 shown in FIG. 2, a printing medium PM is wound around a feeding shaft 20 in a roll shape and is stretched along the transport path. The printing medium PM is recorded with ink while being transported in a first direction Ds (transport direction) from the feeding shaft 20 toward a driving roller 41. The type of the printing medium PM is not limited, and may be a paper-type medium, a film-type medium, or another type of medium. Examples of the paper-type include high-quality paper, cast paper, art paper, and coated paper. Examples of the film-type include synthetic paper, polyethylene terephthalate (PET), and polypropylene (PP).

The printing device 100 includes a feeding unit 2 that feeds the printing medium PM from the feeding shaft 20, a process unit 3 that records (prints) an image on the printing medium PM fed from the feeding unit 2, and a discharge unit 4 that transports, to the post-processing device 200, the printing medium PM on which the image is recorded (printed) by the process unit 3.

In the following description, of both surfaces of the printing medium PM, a surface on which an image is printed is referred to as a front surface, and a surface opposite thereto is referred to as a back surface. The feeding unit 2 includes the feeding shaft 20 around which an end of the printing medium PM is wound, and a driven roller 21 around which the printing medium PM drawn from the feeding shaft 20 is wound. The printing medium PM is wound around the feeding shaft 20 via a core pipe that is detachable from the feeding shaft 20. In the example shown in FIG. 2, when the feeding shaft 20 rotates clockwise, the printing medium PM wound around the feeding shaft 20 is fed to the process unit 3 via the driven roller 21.

The process unit 3 prints an image on the printing medium PM by appropriately performing processing by each of functional units 51, 52, 61, 62, and 63 disposed along an outer circumferential surface of a rotation drum 30 while supporting, by the rotation drum 30, the printing medium PM fed from the feeding unit 2. That is, the process unit 3 includes the rotation drum 30 that rotates while supporting the printing medium PM, the heads 51 and 52 that are disposed at positions facing the rotation drum 30 and that eject the ink onto the printing medium PM supported by the rotation drum 30, and the UV irradiators 61, 62, and 63 that emit UV light to cure the ink.

In the embodiment, the ink ejected from the heads 51 and 52 is a UV ink that is cured by being irradiated with the UV light. By using the UV ink as the ink ejected from the heads 51 and 52, for example, compared to a case where the ink ejected from the heads 51 and 52 is an oil-based ink, it is possible to quickly cure the ink and improve the productivity of printing. Obviously, the ink is not limited to the ink cured by the UV light. When curing by the UV light is not necessary, the UV irradiators 61, 62, and 63 may be omitted.

Further, in the process unit 3, a front driving roller 31 and a rear driving roller 32 are provided on both sides of the rotation drum 30, and the printing medium PM transported from the front driving roller 31 to the rear driving roller 32 is supported by the rotation drum 30 to perform printing.

The front driving roller 31 winds, from the back surface side, the printing medium PM fed from the feeding unit 2. The front driving roller 31 rotates clockwise in FIG. 2 to transport the printing medium PM fed from the feeding unit 2 to downstream of the transport path. A nip roller 31n is provided for the front driving roller 31. The nip roller 31n in a state of being biased to the front driving roller 31 abuts against the front surface of the printing medium PM. The printing medium PM is sandwiched between the nip roller 31n and the front driving roller 31. Accordingly, a friction force between the front driving roller 31 and the printing medium PM is ensured, and the printing medium PM can be reliably transported by the front driving roller 31.

The rotation drum 30 is a rotation drum that rotates while supporting the printing medium PM, and has, for example, a cylindrical shape having a diameter of approximately 400mm. The rotation drum 30 is supported by a support mechanism (not shown) to be rotatable in both the first direction Ds and an opposite direction thereof. The rotation drum 30 winds, from the back surface side, the printing medium PM transported from the front driving roller 31 to the rear driving roller 32. That is, the rotation drum 30 supports the printing medium PM from the back surface side while being driven to rotate in the first direction Ds of the printing medium PM by receiving a friction force with the printing medium PM. A transport speed of the printing medium PM in the process unit 3 (a transport distance of the printing medium PM for a certain period) is mainly controlled by the rotation drum 30.

In the process unit 3, driven rollers 33 and 34 that fold back the printing medium PM are provided on both sides of a winding portion around the rotation drum 30. The driven roller 33 winds the front surface of the printing medium PM between the front driving roller 31 and the rotation drum 30 and folds back the printing medium PM. On the other hand, the driven roller 34 winds the front surface of the printing medium PM between the rotation drum 30 and the rear driving roller 32 and folds back the printing medium PM.

The rear driving roller 32 winds, from the back surface side, the printing medium PM transported from the rotation drum 30 via the driven roller 34. The rear driving roller 32 rotates clockwise in FIG. 2 to transport the printing medium PM to the discharge unit 4. A nip roller 32n is provided for the rear driving roller 32. The nip roller 32n in a state of being biased to the rear driving roller 32 abuts against the front surface of the printing medium PM. The printing medium PM is sandwiched between the nip roller 32n and the rear driving roller 32.

Accordingly, the printing medium PM transported from the front driving roller 31 to the rear driving roller 32 is supported by the outer circumferential surface of the rotation drum 30. In the process unit 3, a plurality of heads 51 corresponding to different colors are provided to print a color image on the front surface of the printing medium PM supported by the rotation drum 30. Specifically, four heads 51 corresponding to yellow, cyan, magenta, and black are arranged in this color order in the first direction Ds. Each head 51 faces the front surface of the printing medium PM wound around the rotation drum 30 with a slight clearance therebetween and ejects ink (colored ink) of a corresponding color from a nozzle by an inkjet method. That is, each head 51 is disposed at a position facing the rotation drum 30 and ejects the ink onto the printing medium PM supported by the rotation drum 30. A color image is printed on the front surface of the printing medium PM by the heads 51 ejecting inks onto the printing medium PM transported in the first direction Ds.

As described above, a UV ink that is cured by being irradiated with UV light (ultraviolet light) is used as the ink. Therefore, in the process unit 3, the UV irradiators 61 and 62 are provided to cure the ink and fix the ink to the printing medium PM. The curing of the ink is executed in two stages of temporary curing and main curing, and the UV irradiators 61 for the temporary curing are each disposed between the plurality of heads 51. The UV irradiator 61 irradiates the ink with ultraviolet rays having a low irradiation intensity to cure (temporarily cure) the ink to such an extent that the wetting and spreading of the ink is sufficiently delayed as compared with a case where the ink is not irradiated with the ultraviolet rays and does not mainly cure the ink. On the other hand, the UV irradiator 62 for the main curing is provided downstream of the plurality of heads 51 in the first direction Ds. That is, the UV irradiator 62 cures (mainly cures) the ink to an extent that the wetting and spreading of the ink is stopped by irradiating the ink with ultraviolet rays having an irradiation intensity stronger than that of the UV irradiator 61.

Accordingly, the UV irradiators 61 each disposed between the plurality of heads 51 temporarily cure the colored inks ejected onto the printing medium PM from the heads 51 upstream in the first direction Ds. Therefore, the ink ejected from one head 51 onto the printing medium PM is temporarily cured before reaching the head 51, downstream in the first direction Ds, adjacent to the one head 51. Accordingly, occurrence of a color mixture such as mixing of colored inks of different colors is prevented. In a state in which the color mixture is prevented in this way, the plurality of heads 51 eject the colored inks of different colors from each other to form a color image on the printing medium PM. Further, the UV irradiator 62 for the main curing is provided downstream of the plurality of heads 51 in the first direction Ds. Therefore, the color image formed by the plurality of heads 51 is mainly cured by the UV irradiator 62 and fixed to the printing medium PM.

Further, the head 52 is provided downstream of the UV irradiator 62 in the first direction Ds. The head 52 faces the front surface of the printing medium PM wound around the rotation drum 30 with a slight clearance therebetween and ejects transparent UV ink from a nozzle onto the front surface of the printing medium PM by an inkjet method.

The UV irradiator 63 is provided downstream of the head 52 in the first direction Ds. The UV irradiator 63 emits strong ultraviolet rays to mainly cure the transparent ink ejected by the head 52. Accordingly, the transparent ink can be fixed to the front surface of the printing medium PM.

Accordingly, in the process unit 3, the ink is appropriately ejected and cured onto the printing medium PM wound around an outer circumferential portion of the rotation drum 30, and a color image coated with the transparent ink is formed. Then, the printing medium PM on which the color image is formed is transported to the discharge unit 4 by the rear driving roller 32.

The discharge unit 4 includes the driving roller 41 for feeding the printing medium PM from the process unit 3 and discharging the printing medium PM to the outside of the printing device 100. The driving roller 41 abuts against the back surface side of the printing medium PM fed from the rear driving roller 32 and sends the printing medium PM to the outside of the printing device 100. A nip roller 41n is provided for the driving roller 41. The nip roller 41n in a state of being biased to the driving roller 41 abuts against the front surface of the printing medium PM. The printing medium PM is sandwiched between the nip roller 41n and the driving roller 41.

In the embodiment, the buffer device 300 is provided between the printing device 100 and the post-processing device 200, and the printing medium PM discharged from the printing device 100 is sent to the buffer device 300. The printing medium PM sent to the buffer device 300 is discharged through a predetermined transport path and sent to the post-processing device 200.

The buffer device 300 accumulates a predetermined amount of the printing medium PM therein, can accumulate the printing medium PM discharged from the printing device 100, and can absorb a difference in the transport speed and a difference in the transport direction of the medium PM between the printing device 100 and the post-processing device 200. Even when the printing device 100 transports the printing medium PM in a direction opposite to the first direction by processing described later, a force in the direction opposite to the first direction acting on the printing medium PM does not act on the printing medium PM in the post-processing device 200. Therefore, in the post-processing device 200, the post-processing can be performed without being affected by a transport operation in the printing device 100.

In the discharge unit 4, an eye mark sensor 42 that reads an eye mark is disposed. The eye mark sensor 42 is disposed close to the printing medium PM downstream of the nip roller 32n in the first direction Ds. The eye mark sensor 42 is disposed such that a position where the eye mark is printed in the direction (width direction of the printing medium) perpendicular to the first direction Ds is provided in a reading range.

The eye mark sensor 42 includes a light emitting unit (not shown) that emits light and a light receiving unit (not shown) that detects light. The light emitting unit includes, for example, a light emitting diode or a tungsten lamp. The light receiving unit includes an optical sensor such as a photodiode, and outputs a signal at a level corresponding to the amount of received light as a detection value. That is, the eye mark sensor 42 detects the presence or absence and the position of the eye mark based on an intensity of light reflected from the printing medium PM.

In the configuration shown in FIG. 2 as described above, the heads 51 and 52 and the UV irradiators 61, 62, and 63 correspond to the printing unit 110. The feeding shaft 20, the driven rollers 21, 33, and 34, the rotation drum 30, the front driving roller 31, the rear driving roller 32, the driving roller 41, and the nip rollers 31n, 32n, and 41n correspond to the transport unit 120. Further, the eye mark sensor 42 corresponds to the reading unit 130.

The printing control unit 140 can issue a control instruction to the transport unit 120 to transport the printing medium PM in the first direction or transport the printing medium PM in the direction opposite to the first direction. That is, when the printing control unit 140 applies a torque to the feeding shaft 20, the front driving roller 31, the rear driving roller 32, and the driving roller 41 in the clockwise direction shown in FIG. 2, the printing medium PM is transported in the first direction. On the other hand, when the printing control unit 140 applies a torque to the feeding shaft 20, the front driving roller 31, the rear driving roller 32, and the driving roller 41 in the counterclockwise direction shown in FIG. 2, the printing medium PM is transported in the direction opposite to the first direction. When the printing medium PM is transported, a torque for rotating the rotation drum 30 may be applied to the rotation drum 30.

In the embodiment, the printing unit 110 includes a cleaning device (not shown). The cleaning device is a device for performing an operation of eliminating dirt or clogging of the heads provided in the printing unit 110. The cleaning device can be implemented by a known configuration. In the embodiment, the printing unit 110 operates the cleaning device according to an instruction from the printing control unit 140 to perform cleaning.

Further, in the embodiment, the printing device 100 includes an error detection device (not shown). The error detection device is a device for detecting whether printing cannot be appropriately performed. The state in which printing cannot be appropriately performed may be various states. Examples of the state include a state in which foreign matter adheres to the printing medium PM, a state in which deviation of the printing medium PM occurs, and a state in which a jam occurs. The error detection device includes sensors for detecting these states, and can be implemented by a known configuration. When the state in which printing cannot be appropriately performed is detected, the error detection device notifies the printing control unit 140 of occurrence of an error. The error detection device may be disposed at a position where a detection target can be detected, and can be implemented by, for example, a part of the transport unit 120.

Further, in the embodiment, the transport unit 120 includes a rotary encoder (not shown), and the printing control unit 140 can specify a time required for rotation of a certain angle based on an output of the rotary encoder. The rotary encoder may be provided in any of rotation bodies provided in the transport unit 120, and for example, in the example shown in FIG. 2, a configuration provided in the rotation drum 30 can be assumed. In this case, the printing control unit 140 can specify a transport distance of the printing medium PM based on the number of pulses output from the rotation drum 30 and the transport distance of the printing medium PM by the rotation drum 30 per pulse. The printing control unit 140 can specify a transport speed of the printing medium PM by dividing the transport distance by a difference in a detection timing of the pulse output from the rotation drum 30.

### Configuration of Post-Processing Device

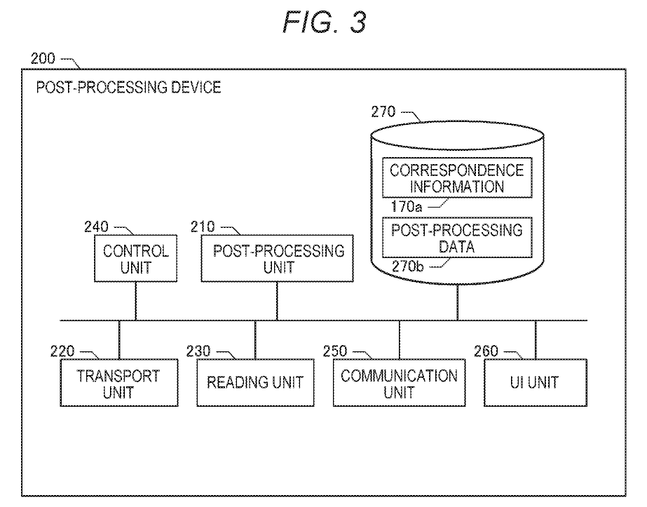

FIG. 3 is a block diagram showing a configuration of the post-processing device 200. The post-processing device 200 includes a post-processing unit 210, a transport unit 220, a reading unit 230, a control unit 240, a communication unit 250, a UI unit 260, and a nonvolatile memory 270.

The control unit 240 includes a CPU as a processor, a ROM, a RAM, and the like, and can execute various programs stored in the nonvolatile memory 270. In the embodiment, the control unit 240 can control each unit of the post-processing device 200 by various programs. That is, the control unit 240 can control the post-processing unit 210, the transport unit 220, the reading unit 230, the communication unit 250, the UI unit 260, and the nonvolatile memory 270.

The control unit 240 may be implemented by a single chip, may be implemented by a plurality of chips, or may be implemented by an SoC together with various function blocks for operating the post-processing device 200. For example, as the processor, an ASIC may be adopted instead of the CPU, or the CPU and the ASIC may cooperate with each other.

Any information can be stored in the nonvolatile memory 270. In the embodiment, the correspondence information 170a and post-processing data 270b are stored. The correspondence information 170a is data transmitted from the printing device 100 and stored in the nonvolatile memory 270. The post-processing data 270b is data indicating a setting for performing the post-processing. A blade mold of the post-processing device 200 according to the embodiment is replaceable, and the post-processing data 270b includes information indicating the blade mold to be used. Obviously, other settings may be provided.

The control unit 240 refers to the post-processing data 270b and permits execution of the post-processing when the designated blade mold is set in the post-processing unit 210. The control unit 240 controls the post-processing unit 210 and the transport unit 220 to repeatedly execute an operation of punching an image from the printing medium. The post-processing data 270b may be recorded in the nonvolatile memory 270 in any form, and for example, it is possible to adopt a configuration in which the printing control unit 140 generates the post-processing data 270b for performing punching according to the printing data 170b and transmits the post-processing data 270b from the printing device 100 to the post-processing device 200, according to an instruction of the user who generates the printing data 170b.

The post-processing unit 210 is a device that executes punching processing, which is post-processing, on the printing medium. The post-processing unit 210 performs punching processing of punching an inside of a contour formed by a blade by lifting and lowering the blade mold using a lifting device (not shown) and pressing the blade mold against the printing medium. In the embodiment, a plurality of blade molds can be simultaneously set in the post-processing unit 210, and punching can be simultaneously performed at a plurality of positions.

The transport unit 220 is a device that transports, in the post-processing device 200, the printing medium PM transported from the printing device 100 and the buffer device 300. In the embodiment, since the post-processing device 200 is disposed in line with the printing device 100, the transport unit 220 transports the printing medium PM in the post-processing device 200 without stopping the flow of the printing medium discharged from the printing device 100 and further discharged from the buffer device 300. That is, the transport unit 220 transports the printing medium PM in the longitudinal direction of the printing medium PM.

The reading unit 230 is a device that reads identification information and an eye mark printed on the printing medium PM. In the embodiment, the reading unit 230 includes an identification information sensor that reads the identification information and an eye mark sensor that reads the eye mark. The reading unit 230 is disposed upstream of the post-processing unit 210, that is, on the side opposite to the first direction in the transport path of the printing medium PM.

In the embodiment, when the job is interrupted and resumed, the identification information is printed on the printing medium PM. The position where the identification information is printed is determined in advance. The identification information sensor is attached to the post-processing device 200 such that the position where the identification information is printed is a reading range. Further, the printing data 170b according to the embodiment includes data for printing the eye mark at a predetermined position on the printing medium. The eye mark sensor is attached to the post-processing device 200 such that the position where the eye mark is printed is a reading range.

The communication unit 250 includes a communication interface for communicating with another device according to various protocols for wired or wireless communication. In the embodiment, the control unit 240 can communicate with the printing device 100 via the communication unit 250. The communication unit 250 may include an interface for communicating with various removable memories attached to the post-processing device 200.

The UI unit 260 includes a touch panel display, a switch, an LED, a speaker, and the like. The UI unit 260 presents various types of information regarding the post-processing device 200 to the user of the post-processing device 200 and receives a user operation under the control of the control unit 240. The communication unit 250 includes a communication interface for communicating with another device according to various protocols for wired or wireless communication.

FIG. 2 also shows a configuration example of the post-processing unit 210, the transport unit 220, and the reading unit 230. The post-processing device 200 includes a driving roller 71 for transporting, into the post-processing device 200, the printing medium PM discharged from the buffer device 300. The driving roller 71 abuts against the back surface side of the printing medium PM fed from the buffer device 300 and sends the printing medium PM to the inside of the post-processing device 200. A nip roller 71n is provided for the driving roller 71. The nip roller 71n in a state of being biased to the driving roller 71 abuts against the front surface of the printing medium PM. The printing medium PM is sandwiched between the nip roller 71n and the driving roller 71. Accordingly, a friction force between the driving roller 71 and the printing medium PM is ensured, and the printing medium PM can be reliably transported by the driving roller 71.

In the post-processing device 200 shown in FIG. 2, the printing medium PM is wound around a winding shaft 70 in a roll shape. The winding shaft 70 winds and supports the end of the printing medium PM in a state in which the front surface of the printing medium PM faces outward. That is, when the winding shaft 70 rotates clockwise in FIG. 2, the printing medium PM transported from the driving roller 71 is wound around the winding shaft 70. The configuration of each roller shown in FIG. 2 is an example, and other rollers may be disposed. The printing medium PM is wound around the winding shaft 70 via a core pipe that is detachable from the winding shaft 70. When the printing medium PM wound around the winding shaft 70 is full, the printing medium PM can be detached together with the core pipe.

In the transport path between the driving roller 71 and the winding shaft 70, a blade mold lifting device 80 that lifts and lowers the blade mold toward the front surface of the printing medium PM during the transport process is provided. The control unit 240 controls the winding shaft 70 and the driving roller 71 to transport and stop the printing medium at certain intervals, and controls the blade mold lifting device 80 to lift and lower the blade mold while the transport is stopped, and then to punch the printing medium PM. The control unit 240 continuously executes this operation.

An eye mark sensor 90 and an identification information sensor 91 are disposed between the blade mold lifting device 80 and the nip roller 71n. The eye mark sensor 90 is disposed close to the printing medium PM upstream of the blade mold lifting device 80 in the first direction Ds. The eye mark sensor 90 is disposed such that a position where the eye mark is printed in the direction (width direction of the printing medium) perpendicular to the first direction Ds is provided in a reading range.

The eye mark sensor 90 includes a light emitting unit (not shown) that emits light and a light receiving unit (not shown) that detects light. The light emitting unit includes, for example, a light emitting diode or a tungsten lamp. The light receiving unit includes an optical sensor such as a photodiode, and outputs a signal at a level corresponding to the amount of received light as a detection value. That is, the eye mark sensor 90 detects the presence or absence of the eye mark based on an intensity of light reflected from the printing medium PM.

The identification information sensor 91 is disposed close to the printing medium PM upstream of the eye mark sensor 90 in the first direction Ds. The identification information sensor 91 is disposed such that the position where the identification information is printed in the direction (width direction of the printing medium) perpendicular to the first direction Ds is provided in the reading range.

The identification information sensor 91 includes a light emitting unit (not shown) that emits light and a two-dimensional sensor (not shown) that detects light. The light emitting unit includes, for example, a light emitting diode or a tungsten lamp. The two-dimensional sensor includes a CCD element, a CMOS element, and the like, and can detect a two-dimensional code. The above configuration is an example, and for example, the eye mark sensor 90 may be omitted, and the eye mark may be detected by the identification information sensor 91.

In the configuration shown in FIG. 2 as described above, the blade mold lifting device 80 corresponds to the post-processing unit 210. The winding shaft 70, the driving roller 71, and the nip roller 71n correspond to the transport unit 220. Further, the eye mark sensor 90 and the identification information sensor 91 correspond to the reading unit 230.

### Printing Processing:

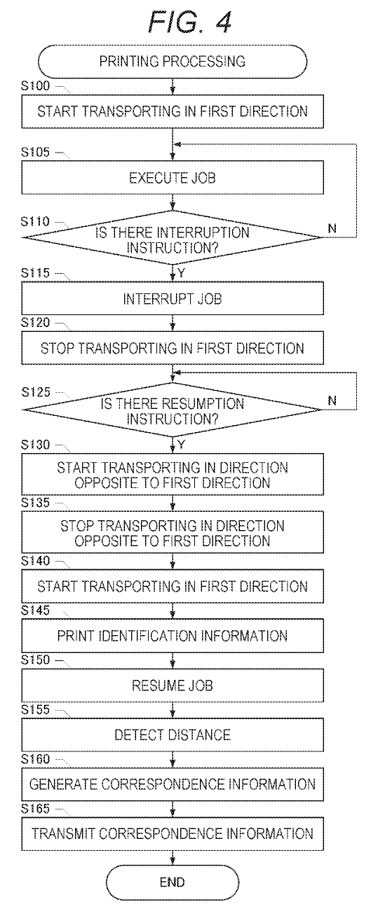

FIG. 4 is a flowchart showing the printing processing. The printing processing shown in FIG. 4 is executed in a state in which the printing medium PM is set in the printing device 100. The printing processing is executed when the user instructs the start of printing on the UI unit 160 of the printing device 100 in a state in which the printing data 170b is generated and stored in the nonvolatile memory 170. Obviously, the generation of the printing data 170b and the printing instruction may be executed by a terminal coupled to the printing device 100.

When the printing processing is started, the printing control unit 140 starts transporting in the first direction (step S100). That is, the printing control unit 140 controls the transport unit 120 to start transporting the printing medium PM in the first direction. At this time, the transport unit 120 applies a torque to each roller in a predetermined procedure, and accelerates the transport speed of the printing medium PM to a predetermined constant speed. The printing device 100 shown in FIG. 2 adopts a relatively large rotation drum 30. Since the rotation drum 30 is a relatively heavy component, it takes a predetermined time to accelerate the rotation drum 30 to the constant speed. The transport unit 120 controls the torque of each roller in a series of predetermined sequences, and accelerates the transport speed to the constant speed. When the transport speed reaches the constant speed, the transport unit 120 continues the transport at the constant speed.

When the transport speed reaches the constant speed, the printing control unit 140 starts execution of the job (step S105). That is, the printing control unit 140 controls the printing unit 110 to print the image indicated by the printing data 170b at the position on the printing medium PM indicated by the printing data 170b. The processing of steps S100 and S105 corresponds to the processing of causing the transport unit 120 to transport the printing medium PM in the first direction and causing the printing unit 110 to continuously print a plurality of images Ip on the printing medium PM.

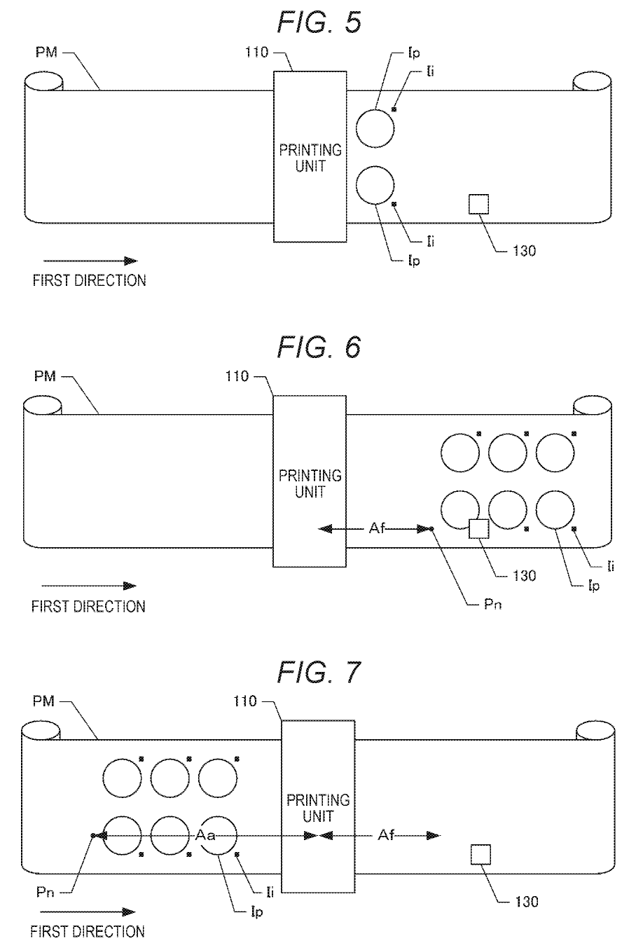

FIG. 5 is a diagram schematically showing a relationship among the printing medium PM, the printing unit 110, and the reading unit 130. FIG. 5 schematically shows a state in which the first direction is a direction toward the right side of the drawing and the front surface of the printing medium PM is viewed from a direction perpendicular to the front surface. FIG. 5 shows an example in which the images Ip and eye mark images Ii punched by the post-processing of the printing unit 110 are printed.

Since the image Ip is an image to be punched by the post-processing device 200 and a position where the blade mold is set in the post-processing device 200 is fixed, the position where the image Ip is to be printed in the printing device 100 is determined in the direction perpendicular to the first direction. The printing data 170b is data for printing the image Ip at the position determined in the direction perpendicular to the first direction.

As described above, the position where the eye mark image Ii is to be printed in the direction (the width direction of the printing medium PM) perpendicular to the first direction is determined in advance. Further, the eye mark image Ii is printed at a position having a predetermined relative positional relationship with the image Ip. The printing data 170b is data for printing the eye mark image Ii at a specific position in the direction perpendicular to the first direction and at a specific distance from the image Ip in the first direction. FIG. 5 shows an example in which the eye mark images Ii are printed at positions corresponding to the two images Ip, respectively, but in the embodiment, since the reading unit 130 is disposed at one position, the eye mark image Ii may be printed at least at a position read by the reading unit 130.

Next, the printing control unit 140 determines whether an interruption instruction is received during the execution of the job (step S110). In the embodiment, it is considered that the interruption instruction is issued at the time of periodic cleaning, error occurrence, or a stop instruction by the user. Specifically, the printing control unit 140 counts, by a clocking circuit (not shown), a time during which the printing by the printing unit 110 is continuously executed. Then, when a duration of printing exceeds a threshold (for example, 40 minutes) after the last cleaning is performed by the cleaning device, the printing control unit 140 determines that there is an interruption instruction.

When the error detection device detects that the printing cannot be performed appropriately, the printing control unit 140 determines that there is an interruption instruction. Further, when the user gives a stop instruction for a job by pressing an emergency stop button and the like using the UI unit 160, the printing control unit 140 determines that there is an interruption instruction.

When it is not determined that the interruption instruction is received in step S110, the printing control unit 140 repeats the processing of step S105 and subsequent steps. That is, the printing control unit 140 continues the execution of the job based on the printing data 170b and repeats the printing of the images Ip and the eye mark images Ii.

On the other hand, when it is determined that the interruption instruction is received in step S110, the printing control unit 140 interrupts the job (step S115). In the embodiment, the printing control unit 140 controls the printing unit 110 to print the image Ip, which is in the middle of printing when the interruption instruction is issued, to the end and not to print the next and subsequent images Ip.

Next, the printing control unit 140 stops transporting in the first direction (step S120). That is, the printing control unit 140 controls the transport unit 120 to decelerate and stop the printing medium PM that has reached the constant speed in step S100. In this case, the transport unit 120 controls the torque of each roller in a series of predetermined sequences and decelerates the transport speed to 0. As described above, since the rotation drum 30 is a relatively large and heavy component, an inertia is relatively large, and it takes a predetermined time to decelerate the transport speed to 0. Therefore, the printing medium PM is transported by a predetermined amount during a period from the interruption to the transport stop, that is, idle running occurs, and an unprinted region occurs between the printing unit 110 and the printed image Ip. In the embodiment, this region is referred to as an idle running region.

FIG. 6 is a diagram showing an idle running region. FIG. 6 schematically shows the printing medium PM around the printing unit 110 in the same form as in FIG. 5. In FIG. 6, a plurality of images Ip and eye mark images Ii have been printed on the printing medium PM, and the image Ip is not printed after an image Ip1 printed last in the first direction. That is, since the transport is continued until the printing medium PM stops after the interruption, an idle running region Af, in which the image Ip is not printed, is generated between the image Ip1 and the printing unit 110. In the embodiment, the idle running region Af is a region from a printing start position Pn of the next image Ip to the printing position in the printing unit 110 in the first direction and is defined in the first direction.

When the transport of the printing medium PM is stopped, the printing control unit 140 determines whether there is a resumption instruction (step S125). When the interruption instruction is generated due to the periodic cleaning, if the printing control unit 140 detects that the cleaning is completed, it is considered that the resumption instruction has been issued. When the interruption instruction is generated due to occurrence of an error, if the printing control unit 140 detects that an error elimination work is completed, it is considered that the resumption instruction has been issued. When the interruption instruction is an instruction from the user, if the user operates the UI unit 160 to issue the resumption instruction, the printing control unit 140 considers that the resumption instruction has been issued.

When it is not determined that there is a resumption instruction in step S125, the printing control unit 140 waits until it is determined that there is a resumption instruction. On the other hand, when it is determined that there is a resumption instruction in step S125, the printing control unit 140 starts transporting in the direction opposite to the first direction (step S130). That is, the printing control unit 140 controls the transport unit 120 to start transporting the printing medium PM in the direction opposite to the first direction. At this time, the transport unit 120 applies a torque in a direction opposite to that in step S100 to each roller in a predetermined procedure.

Further, when the transport amount in the direction opposite to the first direction reaches a predetermined transport amount, the printing control unit 140 stops transporting in the direction opposite to the first direction (step S135). Specifically, the printing control unit 140 performs the transport such that the transport amount of the printing medium PM in the direction opposite to the first direction is a sum of a length of the idle running region Af and a predetermined length Aa for acceleration. That is, the printing control unit 140 transports the printing medium PM in the direction opposite to the first direction by a transport amount larger than the predetermined amount by which the printing medium PM is transported in the first direction during the idle running. FIG. 7 is a diagram showing a state after transport in the direction opposite to the first direction by a transport amount corresponding to the sum of the length of the idle running region Af and the predetermined length Aa for the acceleration. The predetermined length Aa for the acceleration corresponds to a length set such that the transport speed reaches the constant speed when the transport of the printing medium PM is started and accelerated and the printing start position Pn of the next image Ip reaches the printing position in the printing unit 110.

When the transport in the direction opposite to the first direction is stopped, the printing control unit 140 starts transporting in the first direction again (step S140). That is, the printing control unit 140 controls the transport unit 120 in the same manner as in step S100 to start transporting the printing medium PM in the first direction. As a result, the printing medium PM is accelerated in a section of the length Aa, and the transport speed reaches the constant speed.

If the job is resumed in a state in which the transport speed reaches the constant speed by step S140, it is expected that the printing can be started from the printing start position Pn of the next image Ip. However, in the configuration in which the transport direction of the printing medium PM is reversed, since it is difficult to accurately control the transport distance, it is actually difficult to accurately resume the job from the printing start position Pn. When the post-processing such as punching processing is executed, if the next image Ip is printed at a position different from the printing start position Pn, the image is deviated in a punched printed matter.

Therefore, in the embodiment, the printing control unit 140 causes the post-processing device 200 to print, on the printing medium PM, information for accurately aligning the image Ip after printing is resumed. The information is the above-described identification information. That is, in the embodiment, the printing control unit 140 causes the printing unit 110 to print the identification information indicating the occurrence of the interruption of the printing and then resumes the interrupted job.

Specifically, the printing control unit 140 prints the identification information (step S145). That is, in a state in which the printing start position Pn of the next image Ip reaches the printing unit 110 and the transport speed reaches the constant speed, the printing control unit 140 controls the printing unit 110 to print the identification information before resuming the printing of the next image Ip. The identification information is a two-dimensional code, and the printing control unit 140 controls the printing unit 110 to print the two-dimensional code at a position readable by the reading unit 230 of the post-processing device 200. That is, the printing control unit 140 causes the printing unit 110 to print the identification information in a form readable by the post-processing device 200. According to this configuration, it is possible to specify that the interruption is performed by the post-processing device 200 reading the printing medium PM. Therefore, the post-processing device 200 can interrupt the punching processing at the interrupted portion.

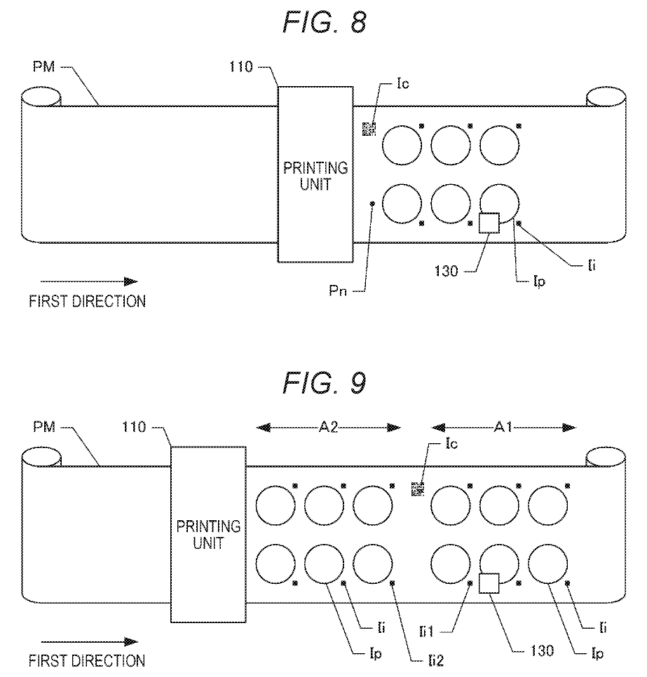

The identification information is different for each interruption. That is, information for identifying each interruption when a plurality of interruptions occur is the identification information. Therefore, the form of the identification information is not limited to the two-dimensional code, and may be information in any form capable of identifying each interruption. FIG. 8 is a diagram showing a state in which identification information Ic of a two-dimensional barcode is printed.

Next, the printing control unit 140 resumes the job (step S150). That is, the printing control unit 140 controls the printing unit 110 to resume the processing of continuously printing the images Ip and the eye mark images Ii indicated by the printing data 170b. FIG. 9 shows an example in which the job is resumed and the images Ip and the eye mark images Ii are printed after the identification information Ic. Although FIG. 9 is a schematic diagram in the same form as that of FIG. 8 and the like, the state of the printing medium PM in a portion downstream of the printing unit 110 is shown to be wider.

Next, the printing control unit 140 detects a distance (step S155). That is, the printing control unit 140 controls the reading unit 130 to acquire information for specifying a distance between the images Ip before and after the interruption of the job. Here, for the sake of description, a region of the printing medium PM in the first direction that has been subjected to printing by the printing unit 110 before the interruption of the job is referred to as the first image region, and a region of the printing medium PM in the first direction that has been subjected to printing by the printing unit 110 after the interruption of the job is referred to as the second image region.

In FIG. 9, the former is shown as a first image region A1, and the latter is shown as a second image region A2. As shown in FIG. 9, in the embodiment, the printing control unit 140 controls the printing unit 110 to print the identification information Ic between the first image region A1 and the second image region A2 in steps S145 and S150. According to the above configuration, it is possible to indicate that the portion on which the identification information Ic is printed is the portion at which the job is interrupted.

The printing control unit 140 controls the reading unit 130 to read a first image included in the first image region A1 and a second image included in the second image region A2. In the embodiment, the first image included in the first image region A1 is an eye mark image Ii1 printed last in the first image region A1 in the first direction. In the embodiment, the second image included in the second image region A2 is an eye mark image Ii2 printed first in the second image region A2 in the first direction.

Therefore, the printing control unit 140 specifies the transport amount of the printing medium PM based on the output of the rotary encoder described above and operates the reading unit 130 before the last eye mark image Ii1 printed before the interruption passes directly below the reading unit 130. The printing control unit 140 specifies a timing at which the reading unit 130 detects the eye mark image Ii1 and a timing at which the reading unit 130 detects the eye mark image Ii2. The printing control unit 140 specifies the transport distance of the printing medium PM between the two marks from a difference between the timings at which the two marks are detected and regards the transport distance as a distance between the two marks. Obviously, a method of acquiring the distance is an example, and for example, a method of acquiring the distance between the eye mark images by constantly performing reading by the reading unit 130 and acquiring the distance when the distance between the eye mark images is larger than a certain distance may be used.

Next, the printing control unit 140 generates correspondence information (step S160). In the embodiment, the correspondence information is information in which identification information and the distance information are associated with each other. As described above, the identification information is information for identifying a specific interruption from among the plurality of interruptions. Therefore, the printing control unit 140 associates the identification information indicating the current interruption with the distance information indicating the distance between the eye mark image Ii1 and the eye mark image Ii2 generated by the interruption. The generated correspondence information 170a is stored in the nonvolatile memory 170.

Next, the printing control unit 140 transmits the correspondence information 170a to the post-processing device 200 via the communication unit 150 (step S165). The transmitted correspondence information 170a is stored in the nonvolatile memory 270. According to this processing, the post-processing device 200 can accurately specify the distance between the eye mark image Ii1 and the eye mark image Ii2 in the portion where the identification information is printed, by referring to the correspondence information.

In the embodiment as described above, the transport unit 120 of the printing device 100 transports the printing medium PM in the first direction during printing and continuously supplies the printing medium after printing to the post-processing device 200 through the buffer device 300. According to this configuration, in the configuration in which the printing and the post-processing are continuously performed, even when the deviation of the printing position occurs due to the interruption in the printing device 100, it is possible to adjust the post-processing according to the deviation in the post-processing device 200, and it is possible to efficiently perform the continuous printing and the continuous post-processing.

### Post-Processing:

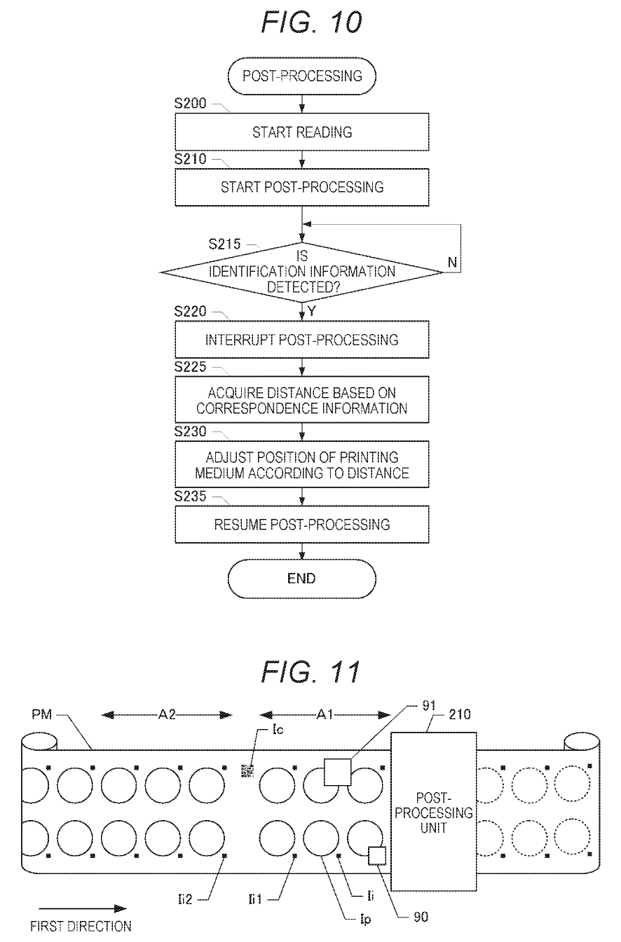

FIG. 10 is a flowchart showing the post-processing. The post-processing shown in FIG. 10 is executed in a state in which the printing medium PM, on which the printing is performed by the printing device 100, is accumulated in the buffer device 300 and the printing medium PM discharged from the buffer device 300 is set in the post-processing device 200. In the embodiment, when the printing medium PM is set in the post-processing device 200, the user adjusts an initial position of the printing medium PM such that the image Ip printed first on the printing medium PM is located at a position to be post-processed by the post-processing unit 210.

After the initial position is adjusted, a timing at which the post-processing unit 210 performs the post-processing is determined by the detection timing of the eye mark image Ii1 of the reading unit 230. The post-processing is executed when the user instructs the start of post-processing on the UI unit 260 of the post-processing device 200 in a state in which the post-processing data 270b is generated and stored in the nonvolatile memory 170. That is, the control unit 240 permits the start of the post-processing when the blade mold indicated by the post-processing data 270b is set in the post-processing unit 210. Obviously, the generation of the post-processing data 270b and the printing instruction may be executed by a terminal coupled to the post-processing device 200. When the correspondence information 170a is generated in the printing device 100, the correspondence information 170a is transmitted to the post-processing device 200 and stored in the nonvolatile memory 270.

When the post-processing is started, the control unit 240 causes the reading unit 230 to start reading (step S200). That is, the control unit 240 controls the reading unit 230 to operate sensors (the identification information sensor 91 and the eye mark sensor 90 in the example shown in FIG. 2) for reading the identification information Ic and the eye mark image Ii. In this state, when the identification information Ic is transported to the reading range of the reading unit 230 in the transport process of the printing medium PM, the reading unit 230 outputs a reading result of the identification information Ic. When the eye mark image Ii is transported to the reading range of the reading unit 230 in the transport process of the printing medium PM, the reading unit 230 detects the eye mark image Ii and outputs information indicating that the eye mark image Ii is detected.

Next, the control unit 240 causes the post-processing unit 210 to start post-processing (step S210). The control unit 240 controls the post-processing unit 210 to punch the image Ip present at the initial position. Thereafter, the control unit 240 controls the transport unit 220 to transport the printing medium PM at a constant speed, and further controls the post-processing unit 210 in synchronization with a reading timing of the eye mark image Ii by the reading unit 230 (the eye mark sensor 90 in the example shown in FIG. 2) to continuously punch the image Ip.

FIG. 11 is a diagram schematically showing a relationship among the printing medium PM, the post-processing unit 210, and the reading unit 230. In FIG. 11, as shown in FIG. 2, a configuration in which the reading unit 230 includes the eye mark sensor 90 and the identification information sensor 91 is assumed, and the position of each sensor is schematically shown. FIG. 11 schematically shows a state in which the first direction is a direction toward the right side of the drawing and the front surface of the printing medium PM is viewed from a direction perpendicular to the front surface. In FIG. 11, the images Ip and the eye mark images Ii printed on the printing medium PM are indicated by solid lines, and the images Ip punched by the post-processing of the post-processing unit 210 are indicated by broken lines. When the post-processing is started, the image Ip is sequentially punched in the post-processing unit 210 as shown in FIG. 11.

Next, the control unit 240 determines whether the identification information is detected during the execution of the post-processing (step S215). That is, when the reading result of the identification information Ic is output from the identification information sensor 91 as the reading unit 230, the control unit 240 determines that the identification information is detected. When it is not determined that the identification information is detected in step S215, the control unit 240 waits until it is determined that the identification information is detected and continues the post-processing.

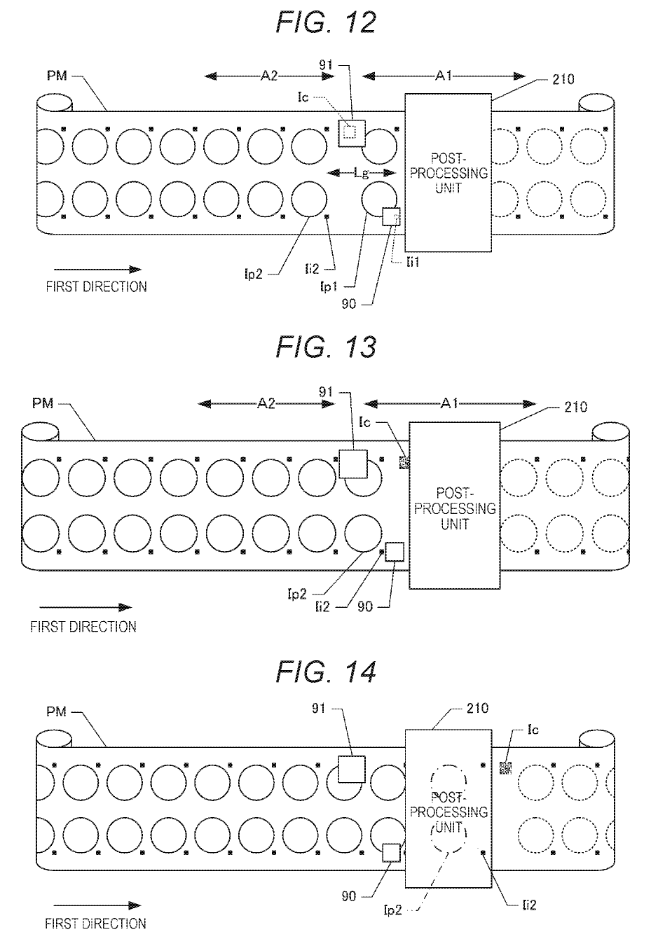

FIG. 12 shows a state in which the identification information Ic is read by the identification information sensor 91. Accordingly, when the identification information Ic is read by the identification information sensor 91, it is determined in step S215 that the identification information is detected. In this case, the control unit 240 interrupts the post-processing (step S220). That is, the control unit 240 controls the post-processing unit 210 to stop the post-processing unit 210 after completing the punching of the image Ip printed last in the first direction in the first image region A1 before the identification information Ic detected in step S215. The control unit 240 controls the transport unit 220 to maintain a state in which the transport of the printing medium PM is stopped after the punching. FIG. 13 is a diagram showing a state in which the post-processing is interrupted.

Next, the control unit 240 acquires a distance based on the correspondence information (step S225). Specifically, the control unit 240 decodes a two-dimensional code as the identification information detected in step S215. The control unit 240 refers to the correspondence information 170a and acquires the distance associated with the decoded identification information. As a result, a distance Lg (see FIG. 12) between the eye mark image Ii1 printed last in the first image region A1 in the first direction and the eye mark image Ii2 printed first in the second image region A2 in the first direction is specified.

Next, the control unit 240 adjusts the position of the printing medium according to the distance Lg (step S230). Specifically, the control unit 240 regards, as the distance acquired in step S225, a distance between the image Ip1 printed last in the first image region A1 in the first direction and an image Ip2 printed first in the second image region A2 in the first direction. That is, the control unit 240 regards, as the distance acquired in step S225, a transport amount by which the printing medium PM is to be transported after the image Ip1 printed last in the first image region A1 in the first direction is punched and before the start of the resumption. Then, the control unit 240 controls the transport unit 220 to perform the transport by the transport amount. As a result, the image Ip2 printed first in the second image region A2 in the first direction is in a state in which the post-processing can be performed by the post-processing unit 210. This state is shown in FIG. 14. The image Ip2 printed first in the second image region A2 in the first direction is indicated by a one-dot chain line.

Next, the control unit 240 resumes the post-processing (step S235). That is, the control unit 240 causes the post-processing unit 210 to punch the image Ip present at a position, at which punching is possible, by adjusting the position in step S230. Thereafter, the control unit 240 controls the transport unit 220 to transport the printing medium PM at a constant speed and further controls the post-processing unit 210 in synchronization with the reading timing of the eye mark image Ii by the eye mark sensor 90 to continuously punch the image Ip.

In the embodiment, the distance Lg between the eye mark image Ii1 printed last in the first image region A1 in the first direction and the eye mark image Ii2 printed first in the second image region A2 in the first direction is accurately specified. Therefore, when the post-processing is resumed, it is possible to accurately perform alignment such that the eye mark image Ii2 printed first in the second image region A2 is at a processing position of the post-processing unit 210. It is possible to automatically adjust the eye mark image Ii2 printed first in the second image region A2 to the processing position of the post-processing unit 210 without manually performing an initial setting again.

### Other embodiments

The above-described embodiment is an example for carrying out the present disclosure, and various other embodiments can be adopted. For example, at least a part of the printing device 100 and the post-processing device 200 of the disclosure may be integrally implemented, and a configuration in which a control unit is common can be adopted. The printing device 100 and the post-processing device 200 may be implemented by a larger number of devices, and a configuration in which the printing device 100 and the post-processing device 200 are controlled by a control terminal may be adopted. In this case, the correspondence information may be transmitted from the control terminal of the printing device 100 to the control terminal of the post-processing device 200. In the above-described embodiment, among the processing shown in FIGS. 4 and 10, the processing that can be omitted may be omitted, or the processing that can be rearranged may be rearranged.

The printing unit may print an image on a printing medium. The printing method is not limited to an inkjet method, and may be an electrophotographic method and the like. That is, any method may be used as long as printing is performed by transporting the printing medium. The image may have any shape formed on the printing medium by a color material. Therefore, information indicated by the image is not limited to a figure, a photograph, and the like, and may be characters, various patterns, and the like. The printing medium may be any type and shape, but in order to continuously print the image, it is preferable that the printing medium is a printing medium accumulated in a roll shape and the like, and is in a form capable of being continuously transported.

The transport unit may be capable of moving the printing unit and the printing medium relative to each other in the first direction. Therefore, the configuration is not limited to the configuration in which the printing medium is transported in the first direction, and may be a configuration in which the printing unit is transported in the first direction, or a configuration in which the direction of the relative movement is the first direction as a result of moving the printing medium and the printing unit. The first direction is a certain direction and is a moving direction of the printing medium or the printing unit at a position where printing is performed.

The reading unit may read the image printed on the printing medium. That is, a distance between images read by the printing control unit or a distance between images printed around the read images may be specified based on positions where the images are read. The configuration for specifying the distance may be various configurations, and is not limited to the configuration using the rotary encoder as in the above-described embodiment. For example, the distance may be specified based on a time length and a transport speed specified from a timing at which the image is read, and various other forms can be adopted.

The printing control unit may control the printing unit, the transport unit, and the reading unit. Obviously, the printing control unit may perform various types of arithmetic processing associated with the control of units. Other parts of the printing device may be controllable.

The job is processing for printing an image according to print settings. The information for executing the job includes information indicating at least an image to be printed and a printing amount of the image (the number of times of printing of the image, the amount of the printing medium required for printing, and the like). Obviously, other information, for example, parameters of image processing on an image, designation of a post-processing device, designation of a form of post-processing, and a delivery destination of a printed matter may be included.

The job to be interrupted is processing of continuously printing images by the printing unit while moving the printing unit and the printing medium relative to each other. That is, when the job is interrupted, the printing of the image is not completed, and a series of processing in which the image to be printed may remain is the job to be interrupted.

The interruption instruction may be generated by various factors. Therefore, the disclosure is not limited to the configuration in which it is considered that the interruption instruction is issued at the time of the periodic cleaning, the error occurrence, or the stop instruction by the user. For example, when the printing medium runs out, it may be considered that the interruption instruction is issued. In this case, an end portion of a printed printing medium and an end portion of a new printing medium may be coupled to each other to form a series of printing media.

The control in the transport unit when the interruption occurs is not limited to the above-described example, and for example, when a distance required for acceleration is short or when the acceleration can be performed until the start of the printing of the second image region, the transport unit may transport the printing medium in the direction opposite to the first direction by the same amount as the idle running amount to resume the printing.

The resumption instruction is processing of instructing the printing control unit to resume the interrupted job. The resumption instruction is not limited to being issued by a user using an interface such as a button of a printing device, and may be generated by various triggers. For example, in the case of the periodic cleaning, when the printing control unit detects that the cleaning is completed, it may be considered that the resumption instruction is issued. Similarly, when an error elimination work is completed after occurrence of an error, it may be considered that the resumption instruction is issued.

The identification information may indicate occurrence of an interruption of printing. Since the printing is resumed after the interruption of the printing, the identification information can be regarded as indicating that the printing is resumed. The identification information may be associated with distance information. That is, when the distance information is associated with the identification information, the distance between the first image region and the second image region before and after the identification information may be specified from the distance information, and confusion with an interrupted portion at another position may not occur.

The identification information may be expressed in various forms, and is not limited to the two-dimensional code as described above. For example, the identification information may be a barcode, a figure having a predetermined shape, or a character. The position where the identification information is printed is also not limited. When the post-processing device reads the identification information, the identification information may be printed at a position read by the post-processing device. Further, the operation after the post-processing device reads the identification information is not limited to the operation of the flowchart shown in FIG. 10, and can be appropriately changed according to the function and configuration of the post-processing device.

The first image region and the second image region are regions defined in the first direction. Therefore, a region on the first direction side with respect to a complete position of the printing before the interruption is the first image region. A region on the side opposite to the first direction with respect to a start position of the printing after the interruption is the second image region.

The distance information may be information on the distance between the first image region and the second image region. That is, a distance between an image printed in the first image region and an image printed in the second image region may be specified. When post-processing such as cutting is performed in the post-processing device, the position may be adjusted such that the post-processing can be performed on each of the image printed in the first image region and the image printed in the second image region. Therefore, the distance information is not limited to the configuration in which the distance between the first image printed last in the first direction in the first image region and the second image printed first in the first direction in the second image region is the distance information. For example, the distance information may be information indicating the distance between an end portion of the first image region and an end portion of the second image region.

The first image and the second image may be images used to define the distance information, and are not limited to dedicated images for specifying the distance information, and may be images constituting a printed matter to be delivered or a part of the images.

Further, the position where the identification information is printed is not limited to the position between the first image region A1 and the second image region A2. That is, the image Ip in the first image region A1 can be continuously post-processed, and the image Ip in the second image region A2 can be continuously post-processed, but since a positional deviation occurs due to an interruption, it is not possible to continuously and accurately perform the post-processing from one region to the other region. Accordingly, the identification information may be printed at a position where the post-processing device 200 can recognize that the continuous processing cannot be performed. That is, the identification information may be printed at a position where the identification information can be read and the reading unit 230 may be disposed at a position where the reading unit 230 can read the identification information until the post-processing of the image printed last in the first image region A1 in the first direction is completed.

As the configuration in which the identification information is printed at a position that is not between the first image region A1 and the second image region A2, for example, a configuration in which the printing control unit 140 controls the printing unit 110 to print the identification information at a position that is within the first image region A1 and is closer to the second image region A2 than a halfway point of the first image region A1 can be adopted. In this range, the identification information is printed at a position not overlapping the image Ip and the eye mark image Ii. In this configuration, the reading unit 230 is disposed at a position where the identification information can be read before the post-processing of the image printed last in the first image region A1 in the first direction is completed. In this configuration, the post-processing device 200 can also recognize that the job is interrupted.

The printing control unit 140 may control the printing unit 110 to print the identification information at a position within the second image region A2 and closer to the first image region A1 than a halfway point of the second image region A2. In this range, the identification information is printed at a position not overlapping the image Ip and the eye mark image Ii. In this configuration, the reading unit 230 is also disposed at a position where the identification information can be read before the post-processing of the image printed last in the first image region A1 in the first direction is completed. In this configuration, the post-processing device 200 can also recognize that the job is interrupted.

Further, in steps S130 and S135, a transport amount when the printing medium PM is transported in the direction opposite to the first direction is not limited to the transport amount in the above-described embodiment. That is, the image Ip that is printed first after the job is resumed may be printed in a state in which the printing medium PM is transported at a constant speed. Therefore, the identification information may be printed in a state in which the printing medium PM is accelerated.

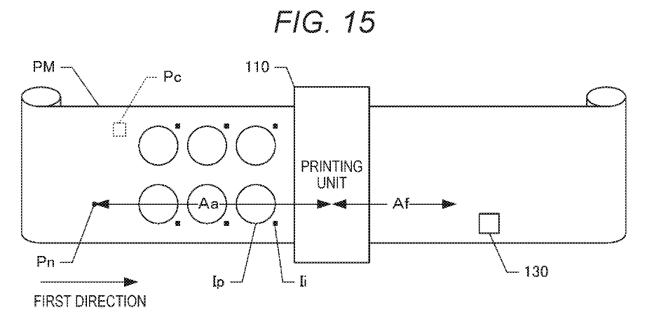

Specifically, in steps S130 and S135 described above, the printing control unit 140 may transport the printing medium PM in the direction opposite to the first direction by a transport amount shorter than a sum of the length of the idle running region Af and the predetermined length Aa for the acceleration. FIG. 15 is a diagram showing an example of a state after the printing medium PM is transported by such a transport amount. In this case, the printing control unit 140 causes the printing unit 110 to print the identification information in a state in which the transport speed of the printing medium PM by the transport unit 120 is increased. In FIG. 15, the position where the identification information is printed is indicated by Pc. Since the position Pc is present closer to the printing unit 110 than the predetermined length Aa for the acceleration, the printing medium PM does not reach the constant speed and is accelerating at a stage where the position Pc reaches the printing unit 110.

Accordingly, in the case of the acceleration, there is a possibility that a printed image quality is lower than in the case of the constant speed, but the identification information may be readable by the reading unit 230, and it is not necessary to have a high image quality. Therefore, as long as the identification information can be read by the reading unit 230, printing during acceleration does not cause any problem. On the other hand, the printing control unit 140 causes the printing unit 110 to print an image in the second image region in a state in which the transport speed of the printing medium PM by the transport unit 120 is constant. In the example shown in FIG. 15, the printing control unit 140 controls the printing unit 110 to print the image Ip after the position Pn. According to the above configuration, since the image Ip can be printed immediately after the printing medium PM reaches the constant speed, it is possible to proceed with printing at a high speed as compared with a configuration in which the identification information is printed after the printing medium PM reaches the constant speed.

The system, the program, and the method as described above may be implemented as a single device or may be implemented by using components provided in a plurality of devices, and may include various forms. Also, suitable changes can be made, such as a part being software and a part being hardware. The disclosure is further implemented as a recording medium for a program for controlling the system. Obviously, the recording medium for the program may be a magnetic recording medium or a semiconductor memory, and any recording medium to be developed in the future can be considered in exactly the same way.

What is claimed is:

1. A printing device comprising:
a printing unit configured to print an image on a printing medium;
a transport unit configured to move the printing medium relative to the printing unit in a first direction;
a reading unit configured to read the image printed on the printing medium; and
a printing control unit configured to control the printing unit, the transport unit, and the reading unit, wherein
the printing control unit causes the transport unit to move the printing medium relative to the printing unit in the first direction, interrupts execution of a job, in which the printing unit continuously prints a plurality of images on the printing medium, when an interruption instruction is received during the execution of the job, and causes the printing unit to print identification information indicating occurrence of interruption of printing, and then resumes the interrupted job when a resumption instruction is received, and
when a region of the printing medium in the first direction that has been subjected to printing by the printing unit before the interruption is defined as a first image region, and a region of the printing medium in the first direction that has been subjected to printing by the printing unit after the interruption is defined as a second image region, the printing control unit causes the reading unit to read a first image included in the first image region and a second image included in the second image region, acquires distance information that is information regarding a distance between the first image region and the second image region, and associates the identification information with the distance information.

2. The printing device according to claim 1, wherein
the printing control unit controls the printing unit to print the identification information between the first image region and the second image region.

3. The printing device according to claim 1, wherein
the printing control unit controls the printing unit to print the identification information at a position within the first image region and closer to the second image region than halfway point of the first image region, or at a position within the second image region and closer to the first image region than halfway point of the second image region.

4. The printing device according to claim 1, wherein
the printing control unit transmits correspondence information, which is information in which the identification information and the distance information are associated with each other, to a post-processing device that performs post-processing of the printing.

5. The printing device according to claim 1, wherein
the printing control unit causes the printing unit to print the identification information in a manner readable by a post-processing device that performs post-processing of the printing.

6. The printing device according to claim 1, wherein
the transport unit transports the printing medium in the first direction during printing, and continuously supplies the printing medium after the printing to a post-processing device that performs post-processing of the printing.

7. The printing device according to claim 1, wherein
the transport unit transports the printing medium in the first direction during printing,
the printing control unit causes the transport unit to transport the printing medium in the first direction by a predetermined amount after the printing control unit receives the interruption instruction, and
when the resumption instruction is received, the printing control unit causes the transport unit to transport the printing medium in a direction opposite to the first direction by an amount more than the predetermined amount and then causes the transport unit to transport the printing medium in the first direction again to resume the interrupted job.

8. The printing device according to claim 1, wherein
the transport unit transports the printing medium in the first direction during printing, and
the printing control unit
causes the printing unit to print the identification information in a state in which a transport speed of the printing medium by the transport unit is increasing, and
causes the printing unit to print an image in the second image region in a state in which the transport speed of the printing medium by the transport unit is constant.

9. A printing control method for controlling a printing device, wherein
the printing device includes
a printing unit configured to print an image on a printing medium,
a transport unit configured to move the printing medium relative to the printing unit in a first direction, and
a reading unit configured to read the image printed on the printing medium, and
the printing control method comprises:
causing the transport unit to move the printing medium relative to the printing unit in the first direction, causing the printing unit to interrupt the execution of a job, in which the printing unit continuously prints a plurality of images on the printing medium, when an interruption instruction is received during the execution of the job, and printing, by the printing unit, identification information indicating occurrence of interruption of printing, and then resuming the interrupted job when a resumption instruction is received; and
when a region of the printing medium in the first direction that has been subjected to printing by the printing unit before the interruption is defined as a first image region, and a region of the printing medium in the first direction that has been subjected to printing by the printing unit after the interruption is defined as a second image region, reading, by the reading unit, a first image included in the first image region and a second image included in the second image region, and associating the identification information with distance information that is information regarding a distance between the first image region and the second image region.
